(19) United States
(12) Patent Application Publication
(10) Pub. No.: US 2026/0248142 A1
(43) Pub. Date: Aug. 27, 2026

(54) METHOD FOR MAKING STRUCTURALLY REINFORCED BAKING TRAYS

(71) Applicant: GWR Holdings LLC, Urbana, OH (US)

(72) Inventors: S. Douglas Anthony, Urbana, OH (US); Bradley D. Swords, Urbana, OH (US)

(21) Appl. No.: 19/059,849

(22) Filed: Feb. 21, 2025

(51) Int. Cl. A21B 3/13

(52) U.S. Cl. CPC A21B 3/13

(57) ABSTRACT

A method for making a baking tray, comprising fabricating a supportive frame for a baking tray, wherein the supportive frame includes two opposing endwalls, two opposing sidewalls, and an interior region; forming at least one bracket tab in each sidewall of the supportive frame, wherein each bracket tab formed in a sidewall is located directly across from a corresponding bracket tab formed in the opposing sidewall, thereby forming one or more pairs of corresponding bracket tabs; bending each of the bracket tabs inward 90° toward the interior region of the supportive frame; and attaching a cross brace to each opposing pair of bracket tabs for providing structural support to the baking tray.

### BACKGROUND

The disclosed technology relates in general to systems, methods, and devices used in industrial and commercial baking environments and baking processes, and more specifically to a method for making a structurally reinforced baking pans and trays.

Baking pans or trays are commonly used by producers of various baked goods that are supplied to restaurants and grocery stores. Because producers of baked goods often supply large quantities of baked goods to their customers, the trays on which these goods are baked are typically reused many times and are repeatedly subjected to both high thermal and mechanical stresses. Repeated use and repeated exposure to high temperatures and mechanical stress requires that an industrial baking tray be manufactured from a durable material such as steel or aluminum Although manufacturing a baking tray from materials such as steel or aluminum does increase the lifespan of the tray, additional features may be included to lend strength and stability, particularly when the tray is large. One approach for adding strength and durability to industrial baking pans and trays includes fabricating a metal baking surface, attaching the metal baking surface to a rigid and structurally supportive frame, and then adding supportive cross braces to the frame to provide additional structural support, enhance and increase durability, and prevent or reduce warping and/or undesired flexing of the baking surface.

Previous methods for adding one or more supportive cross braces to the frame of an industrial baking pan or tray requires adding attachment points for the cross braces to the interior sidewall of the frame. These attachment points are typically provided by angle brackets that consist of pieces of material cut from a coil that are welded to the interior sidewall of the frame. This angle bracket installation process is expensive and time-consuming because it requires an operator to cut the bracket material from a coil, an operator to bend the brackets ninety degrees on a press brake, and a welder to individually weld the brackets to the pan frame. Accordingly, there is an ongoing need for a more efficient and cost-effective process for attaching cross braces to the frame of industrial baking pans or trays.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One example implementation of the disclosed technology provides a first method for making a baking tray comprising fabricating a supportive frame for a baking tray, wherein the supportive frame includes two opposing endwalls, two opposing sidewalls, and an interior region; forming at least one bracket tab in each sidewall of the supportive frame, wherein each bracket tab formed in a sidewall is located directly across from a corresponding bracket tab formed in the opposing sidewall, thereby forming one or more pairs of corresponding bracket tabs; bending each of the bracket tabs inward 90° toward the interior region of the supportive frame; and attaching a cross brace to each opposing pair of bracket tabs for providing structural support to the baking tray.

Implementations of the disclosed first method further comprise using a laser to fabricate the supportive frame and bracket tabs from a piece of material, wherein the piece of material is metal. Implementations of the disclosed method further comprise attaching a plurality of individual baking subunits (baking molds) to the supportive frame. Implementations of the disclosed method further comprise using a tool to bend each of the bracket tabs inward 90° toward the interior region of the supportive frame, wherein the tool is configured to cooperate with a structural feature of the bracket tab to facilitate bending the bracket tab, and wherein the tool includes a tool stop configured to prevent over-bending of the bracket tab. Implementations of the disclosed method further comprise welding each cross brace to a pair of bracket tabs to provide structural support to the baking tray. The pairs of bracket tabs may be formed on the endwalls or on both the endwalls and the sidewalls, and the supportive cross braces are mounted between these pairs of bracket tabs. Implementations of the disclosed method further comprise configuring the supportive frame as a box channel having a panel configured to receive individual baking molds or as a channel frame configured to receive a baking surface having individual baking subunits formed therein. Other configurations of the supportive frame are possible.

Another example implementation of the disclosed technology provides a second method for making a baking tray comprising using a laser to fabricate a supportive frame from a piece of metal, wherein the supportive frame is configured for use with a baking tray, and wherein the supportive frame includes two opposing endwalls, two opposing sidewalls, and an interior region; forming at least one bracket tab in each sidewall of the supportive frame, wherein each bracket tab formed in a sidewall is located directly across from a corresponding bracket tab formed in the opposing sidewall, thereby forming one or more pairs of corresponding bracket tabs; attaching a plurality of individual baking subunits (baking molds) to the supportive frame, wherein each of the baking units has a predetermined geometry; bending each of the bracket tabs inward 90° toward the interior region of the supportive frame; and attaching a cross brace to each opposing pair of bracket tabs for providing structural support to the baking tray.

Implementations of the disclosed second method further comprise using a tool to bend each of the bracket tabs inward 90° toward the interior region of the supportive frame, wherein the tool is configured to cooperate with a structural feature of the bracket tab to facilitate bending the bracket tab, and wherein the tool includes a tool stop configured to prevent over-bending of the bracket tab. Implementations of the disclosed method further comprise welding each cross brace to a pair of bracket tabs to provide structural support to the baking tray. In various implementations the pairs of bracket tabs are formed on the endwalls or on both the endwalls and the sidewalls and the supportive cross braces are mounted between these pairs of bracket tabs. The supportive frame may be configured as a box channel having a panel configured to receive individual baking molds or as a channel frame configured to receive a baking surface having individual baking subunits formed therein. Other configurations of the supportive frame are possible.

Still another example implementation of the disclosed technology provides a baking tray comprising a supportive frame, wherein the supportive frame includes two opposing endwalls, two opposing sidewalls, and an interior region; at least one bracket tab formed in each sidewall of the supportive frame, wherein each bracket tab formed in a sidewall is located directly across from a corresponding bracket tab formed in the opposing sidewall, thereby forming one or more pairs of corresponding bracket tabs, and wherein each bracket tab is bent inward 90° toward the interior region of the supportive frame; a plurality of baking subunits attached to the supportive frame; and a cross brace attached to each opposing pair of bracket tabs for providing structural support to the baking tray.

In various implementations, the supportive frame is configured as either a box channel or a channel frame. In various implementations, the supportive frame is laser cut from a single piece of metal, and each bracket tab is laser cut into the frame. In various implementations, each individual baking subunit in the plurality of baking subunits is configured as a baking mold. In various implementations, the pairs of bracket tabs are formed on the endwalls or on both the endwalls and the sidewalls, and wherein the supportive cross braces are mounted between these pairs of bracket tabs. In various implementations, each cross brace is welded to a pair of bracket tabs to provide structural support to the baking tray.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1A is a top view of an example industrial baking pan that includes multiple individual baking molds, a supportive frame, and a structurally supportive cross brace mounted to the supportive frame;

FIG. 1B is a partial cross-sectional side view of the baking pan of FIG. 1A showing a bracket tab formed in the sidewall of the frame and individual baking molds mounted in and attached to the frame;

FIG. 2A is an exploded perspective view of a prior art baking pan frame, wherein a supportive cross brace is attached to the sidewalls of the frame using a pair of L-brackets formed from material separate from the material of the frame itself;

FIG. 2B is a perspective view of the baking pan frame of FIG. 2A shown in an assembled configuration, wherein the L-brackets have been welded to the interior sidewall of the frame, and wherein the cross brace has been welded to the L-brackets;

FIG. 3A is an exploded perspective view of the bottom portion of the supportive frame of a baking pan such as that shown in FIG. 1A, wherein a supportive cross brace has been attached to the sidewalls of the frame using a pair of integral bracket tabs formed from the material of the sidewalls themselves and bent inward 90°;

FIG. 3B is a perspective view of the baking pan frame of FIG. 3A shown in an assembled configuration, wherein the cross brace has been welded to the bracket tabs;

FIG. 3C is a detail of the region shown as A in FIG. 3B showing the appearance of the point of connection between the bracket tab and the cross brace;

FIG. 4A is a side view of an example embodiment of a hand tool which is used to bend the bracket tabs inward 90° from the sidewall of the supportive frame for properly positioning the bracket tab for attachment to the cross brace;

FIG. 4B depicts the tool of FIG. 4A engaging a bracket tab that has not yet been bent inward, wherein a hook formed on a distal portion of the tool engages an aperture formed in the material of the sidewall;

FIG. 4C depicts the tool of FIG. 4A moved into a forward position such that the bracket tab is bent inward 90° and a tool stop formed on the tool abuts the exterior of the sidewall to prevent the bracket tab from being bent beyond 90°;

FIG. 4D depicts a bracket tab bent inward 90°; and

FIG. 5 is a flowchart of an example implementation of the disclosed method for making a structurally reinforced baking pan.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The various embodiments and implementations disclosed and discussed herein are examples only and are provided to assist in the explanation of the apparatuses, devices, systems, and methods described herein. None of the features or components shown in the drawings or discussed below should be taken as required for any specific implementation of any of these apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, unless otherwise specified or required by context, any explicit or implicit ordering of steps performed in the execution of a method does not imply that those steps must be performed in the order presented but instead may be performed in a different order or in parallel.

The disclosed technology provides a method for making an industrial or commercial baking pan or tray. An example implementation of the disclosed method includes fabricating a supportive frame from a piece of material (e.g., aluminum or steel) using a laser. The supportive frame includes a top panel, two opposing endwalls, two opposing sidewalls, and an interior region between the sidewalls and the endwalls. At least one bracket tab is formed in each sidewall of the supportive frame during the same laser-based process used to initially cut the supportive frame. Each bracket tab is formed in a sidewall, from the material of the sidewall itself, and is located directly across from a corresponding bracket tab formed in the opposing sidewall, thereby forming one or more pairs of corresponding bracket tabs. An plurality of individual baking subunits configured as cups or having other predetermined geometries or shapes, are attached to the supportive frame. Each bracket tab is bent inward 90° toward the interior region of the supportive frame and a rigid cross brace is attached (e.g., welded) to each opposing pair of bracket tabs for providing structural support to the baking tray.

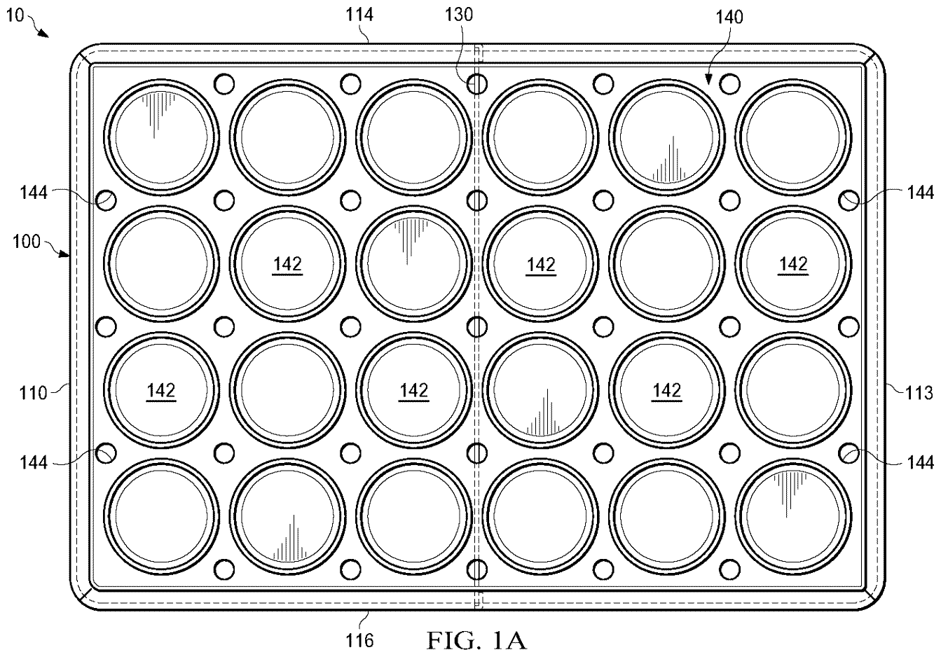

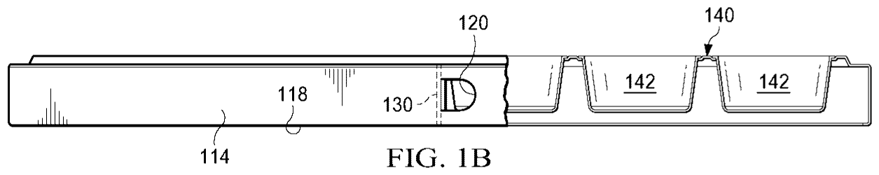

With reference to the Figures, FIG. 1A provides a top view of a stackable baking pan constructed in accordance with an exemplary implementation of the disclosed method, wherein the baking pan includes a supportive frame, and wherein a structurally supportive cross brace has been mounted to the bottom portion of the supportive frame. FIG. 1B provides a partial cross-sectional side view of the baking pan of FIG. 1A. More specifically, as shown in the Figures, baking pan 10 includes supportive frame 100, which includes end wall 110, end wall 112, side wall 114, and side wall 116. Heat holes 118 are formed at various locations along the length of the sidewalls (114,116) and/or the end walls (110,112). A bracket tab (120) is formed in both sidewalls (114,116) and is bent inward 90°, using either a manual process or an automated process, thereby forming an attachment point for cross brace 130, which is welded to the inwardly bent portions of bracket tabs 120. Cross brace 130 is typically fabricated from aluminized steel or other suitable metal. Baking panel 140 is formed integrally with and perpendicular to sidewalls 114 and 116 and end walls 110 and 112 and includes a plurality of apertures configured to receive individual baking subunits or molds 142 (having one or more predetermined geometries). Molds 142 are attached to panel 140 using any of a variety of known fabrication techniques (e.g., seaming). The supportive frame and molds are also typically fabricated from aluminized steel or other suitable metal. A plurality of heat holes 144 are formed in baking surface 140 and are positioned between molds 142.

The configuration of baking tray 10 shown in FIGS. 1A-1B is referred to as a “box channel”. The baking panel, sidewalls, and end walls are all formed from the same piece of material and the baking molds are mounted in and attached (pressed or seamed) to the baking panel. The disclosed method may also used with other pan designs and configurations such as, for example, a “channel frame” wherein a separate baking surface that includes a plurality of baking subunits formed therein is fabricated and then attached to a frame that is the reinforced with a cross bar welded to bracket tabs that have been cut into the frame as described herein. One of ordinary skill in the art will appreciate that the disclosed bracket tabs, tool, and supportive cross bar may be used with various pan configurations.

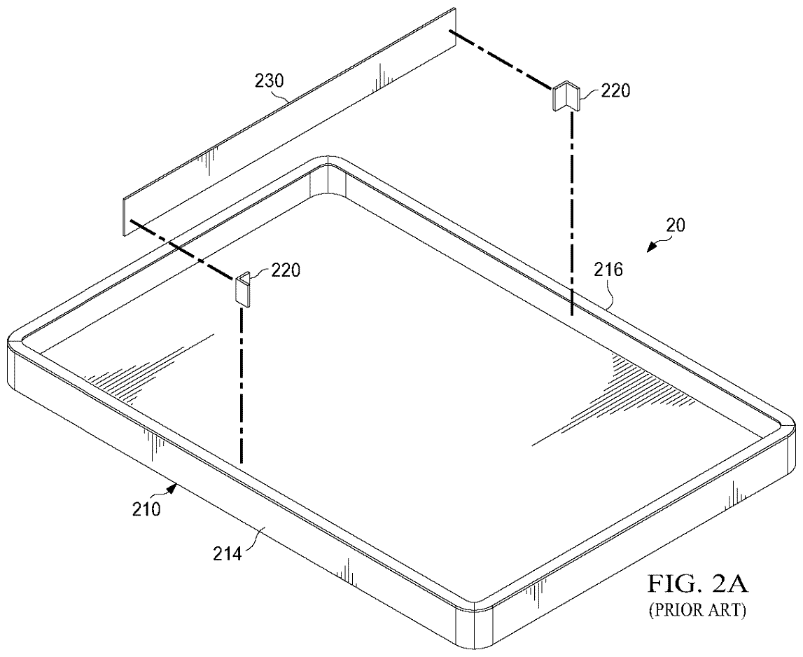

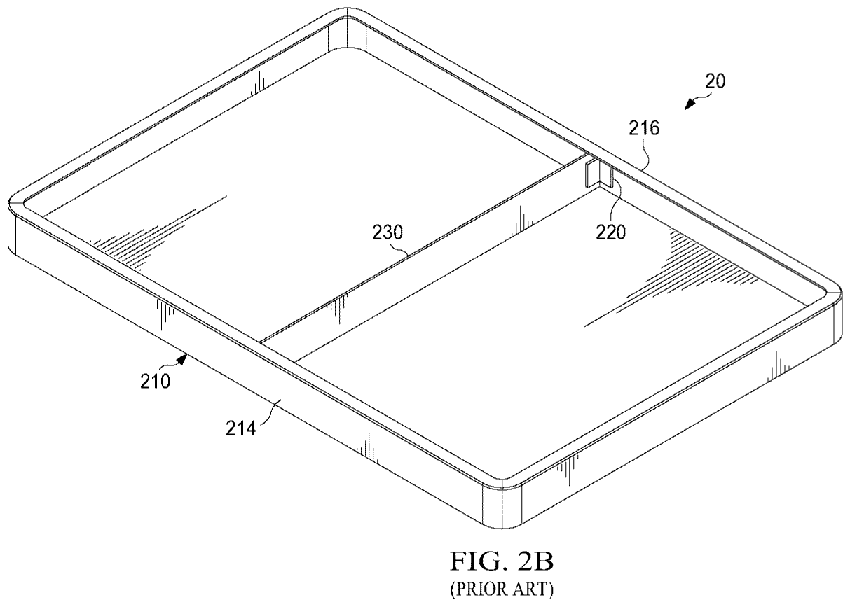

FIG. 2A provides a partially exploded perspective view of a prior art baking pan 20 (box channel configuration), wherein a supportive cross brace (230) is positioned for attachment to the sidewalls (214,216) of a frame (200) using a pair of L-brackets (220) formed from a material (e.g., metal coil) that is separate from the material of the frame itself. FIG. 2B provides a perspective view of baking pan 20 shown in an assembled configuration, wherein L-brackets 220 have been welded to the interior sidewall of frame 200, and wherein cross brace 230 has been welded to L-brackets 220. As discussed below, the disclosed method provides significant advantages over the approach depicted in FIGS. 2A-2B.

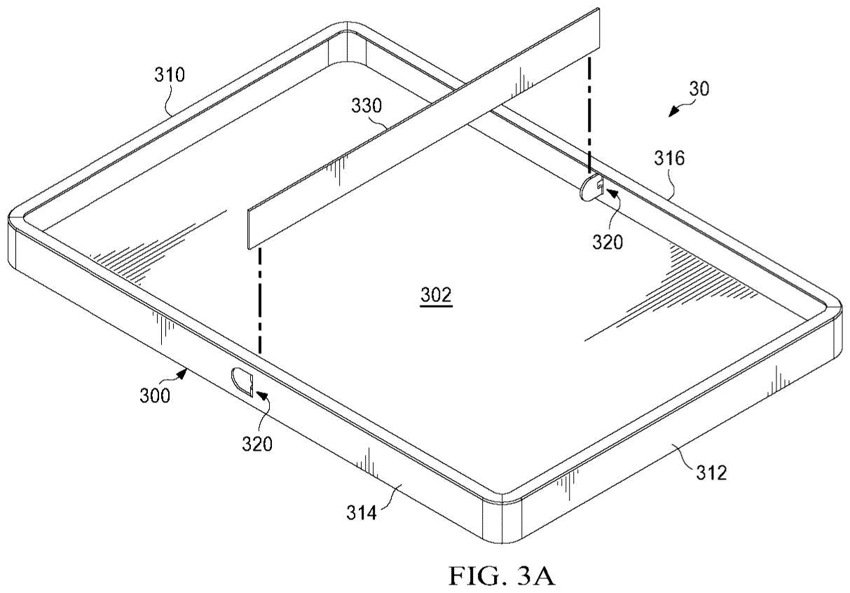

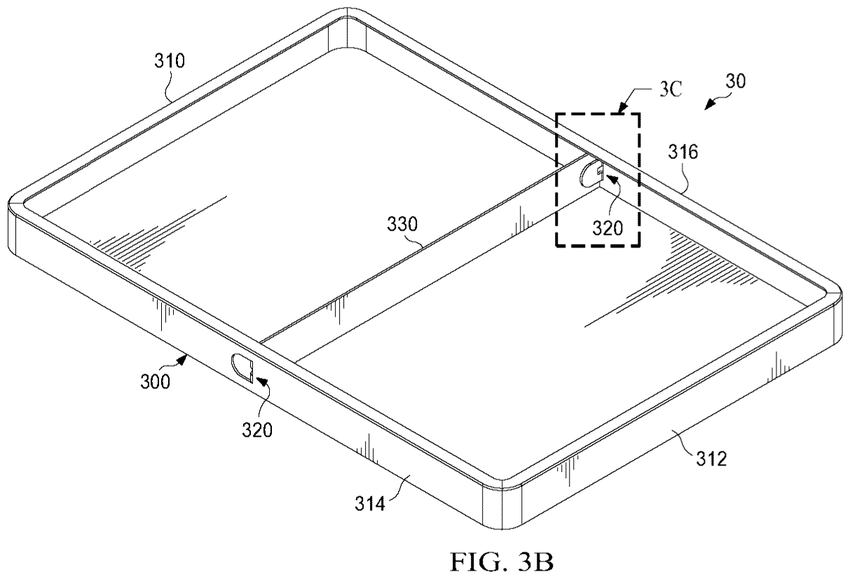

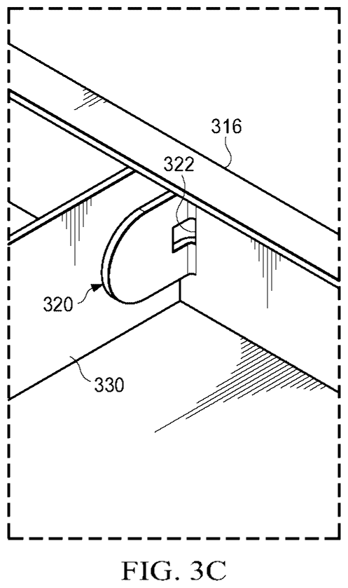

FIG. 3A provides a partially exploded perspective view of a baking pan 30 (box channel configuration), wherein a supportive cross brace (330) is positioned for attachment to the sidewalls (314,316) of a frame (300) using a pair of integral bracket tabs formed from the material of the sidewalls and bent inward 90° (the baking pan panel/upper portion of the frame is not shown in FIGS. 3A-3C). As shown in FIG. 3A, frame 30 includes frame 300, interior region 302, end wall 310, opposing end wall 312, side wall 314, opposing side wall 316, bracket tab 320 (which includes aperture 322), and cross brace 330. FIG. 3B provides a perspective view of baking pan 30, wherein cross brace 330 has been welded to bracket tabs 320. FIG. 3C provides a detail of the region shown as “A” in FIG. 3B showing the appearance of the point of connection between a bracket tab (320) and a cross brace (330).

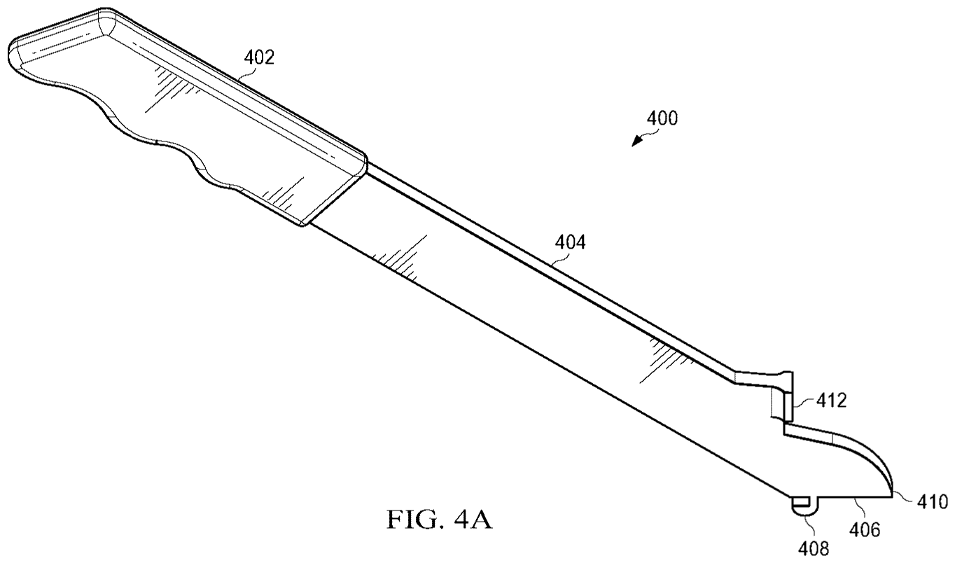

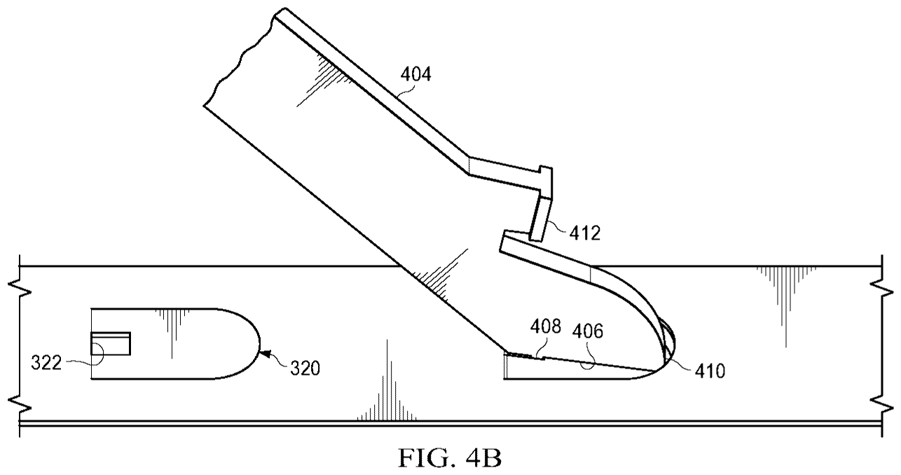

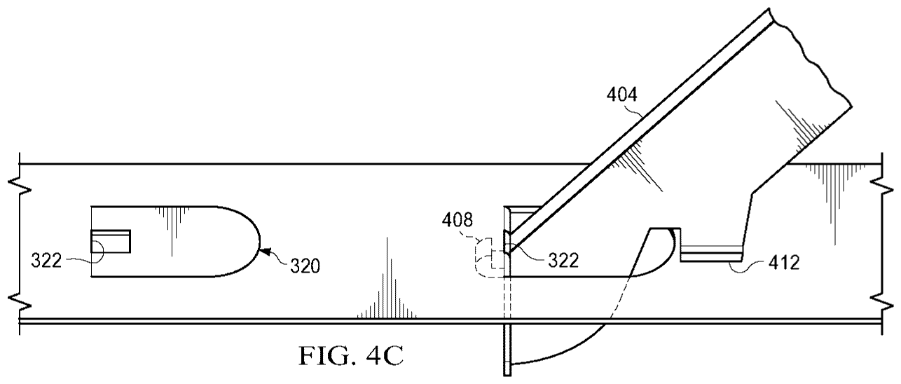

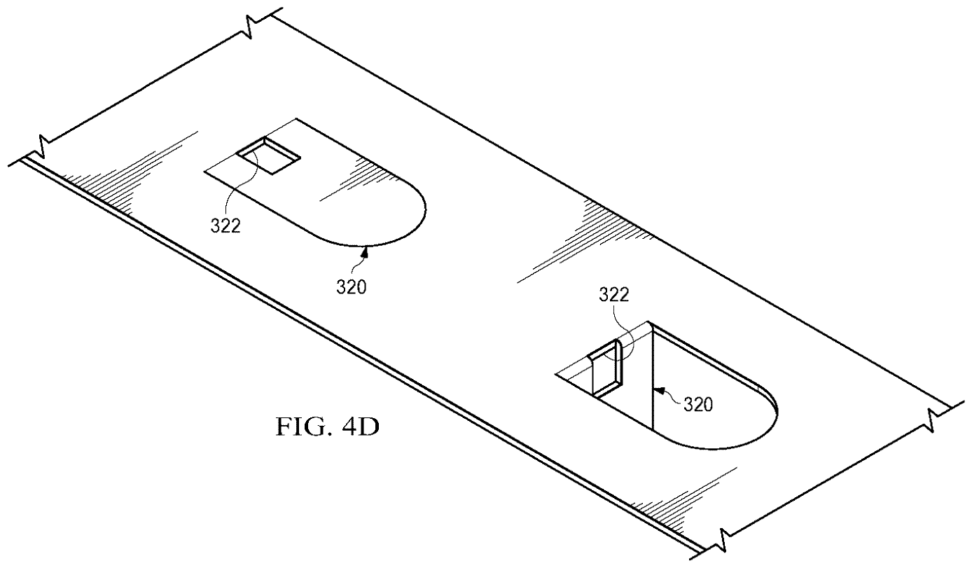

In some embodiments or implementations of the disclosed methodology, bracket tabs 320 are bent into the proper attachment position for cross brace 330 using a manual technique that utilizes a tool specifically configured for this purpose. As shown in FIGS. 4A-4D, an example bracket tab bending tool 400 includes handle 402, elongated body 404, tab engagement device 406, post or hook 408, distal portion 410, and tool stop 412. FIG. 4A provides a side view of an example embodiment of hand tool 400 which is used to bend bracket tabs 320 inward 90° from the sidewalls (314,316) of supportive frame 300 for properly positioning bracket tabs 320 for attachment to cross brace 330. FIG. 4B depicts bracket tab bending tool 400 engaging a bracket tab (320) that has not yet been bent inward. Hook 408 engages an aperture (322) formed in the material of the sidewall (314,316) for properly positioning tool 400. FIG. 4C depicts bracket tab bending tool 400 moved forward into a position wherein bracket tab 320 is bent inward 90° and tool stop 412, which is formed on tab engagement device 406, abuts the exterior of the sidewall (314, 316) thereby preventing bracket tab 320 from being bent beyond 90°. FIG. 4D depicts bracket tab 320 bent inward 90° to a desired position.

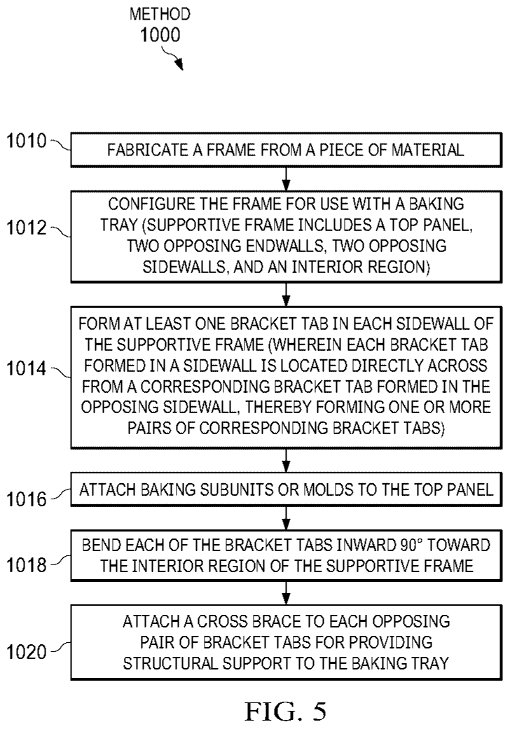

FIG. 5 is a flowchart of an example implementation of the disclosed method for making structurally reinforced baking pans. In FIG. 5, method 1000 includes fabricating a frame from a piece of material at process step 1010; configuring the frame for use with a baking tray (wherein the supportive frame includes two opposing endwalls, two opposing sidewalls, and an interior region) at process step 1012; forming at least one bracket tab in each sidewall of the supportive frame (wherein each bracket tab formed in a sidewall is located directly across from a corresponding bracket tab formed in the opposing sidewall, thereby forming one or more pairs of corresponding bracket tabs) at process step 1014; attaching baking subunits to the supportive frame at process step 1016; bending each of the bracket tabs inward 90° toward the interior region of the supportive frame at process step 1018; and attaching a cross brace to each opposing pair of bracket tabs for providing structural support to the baking tray at process step 1020.

Compared to previously known methods for making structurally reinforced industrial baking pans and trays, the disclosed method requires fewer operators, less machinery, and less material. The laser process used to create the frame may also be used to create the bracket tabs and this process is typically fully automated. Forming the integral bracket tabs from the material of the frame sidewalls eliminates the costs and labor associated with using steel coil for L-brackets, bending the L-brackets into the required shape, and welding the L-bracket to the frame of the baking tray. Both cutting the bracket tabs into the frame and bending the bracket tabs (using the disclosed tool or by other automated or manual means) can be accomplished in a fraction of the time associated with the L-bracket approach. Laser cutting the bracket tabs into the frame also provides greater accuracy for cross-brace placement, and eliminating the use of L-brackets results in a weight savings of approximately 0.05 lbs per cross brace.

If applicable, all literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A method for making a baking tray, comprising:
(a) fabricating a supportive frame for a baking tray, wherein the supportive frame includes two opposing endwalls, two opposing sidewalls, and an interior region;
(b) forming at least one bracket tab in each sidewall of the supportive frame, wherein each bracket tab formed in a sidewall is located directly across from a corresponding bracket tab formed in the opposing sidewall, thereby forming one or more pairs of corresponding bracket tabs;
(c) bending each of the bracket tabs inward 90° toward the interior region of the supportive frame; and
(d) attaching a cross brace to each opposing pair of bracket tabs for providing structural support to the baking tray.

2. The method of claim 1, further comprising using a laser to fabricate the supportive frame and bracket tabs from a piece of material, wherein the piece of material is metal.

3. The method of claim 1, further comprising attaching a plurality of individual baking subunits or molds to the supportive frame.

4. The method of claim 1, further comprising using a tool to bend each of the bracket tabs inward 90° toward the interior region of the supportive frame, wherein the tool is configured to cooperate with a structural feature of the bracket tab to facilitate bending the bracket tab, and wherein the tool includes a tool stop configured to prevent over-bending of the bracket tab.

5. The method of claim 1, further comprising welding each cross brace to a pair of bracket tabs to provide structural support to the baking tray.

6. The method of claim 1, wherein the pairs of bracket tabs are formed on the endwalls or on both the endwalls and the sidewalls, and wherein supportive cross braces are mounted between these pairs of bracket tabs.

7. The method of claim 1, further comprising configuring the supportive frame as a box channel having a panel configured to receive individual baking molds.

8. The method of claim 1, further comprising configuring the supportive frame as a channel frame configured to receive a baking surface having individual baking subunits formed therein.

9. A method for making a baking tray, comprising:
(a) using a laser to fabricate a supportive frame from a piece of metal,
(i) wherein the supportive frame is configured for use with a baking tray, and
(ii) wherein the supportive frame includes two opposing endwalls, two opposing sidewalls, and an interior region;
(b) forming at least one bracket tab in each sidewall of the supportive frame, wherein each bracket tab formed in a sidewall is located directly across from a corresponding bracket tab formed in the opposing sidewall, thereby forming one or more pairs of corresponding bracket tabs;
(c) attaching a plurality of individual baking subunits to the supportive frame, wherein each of the baking units has a predetermined geometry;
(d) bending each of the bracket tabs inward 90° toward the interior region of the supportive frame; and
(e) attaching a cross brace to each opposing pair of bracket tabs for providing structural support to the baking tray.

10. The method of claim 9, further comprising using a tool to bend each of the bracket tabs inward 90° toward the interior region of the supportive frame, wherein the tool is configured to cooperate with a structural feature of the bracket tab to facilitate bending the bracket tab, and wherein the tool includes a tool stop configured to prevent over-bending of the bracket tab.

11. The method of claim 9, further comprising welding each cross brace to a pair of bracket tabs to provide structural support to the baking tray.

12. The method of claim 9, wherein the pairs of bracket tabs are formed on the endwalls or on both the endwalls and the sidewalls, and wherein supportive cross braces are mounted between these pairs of bracket tabs.

13. The method of claim 9, further comprising configuring the supportive frame as a box channel having a panel configured to receive individual baking molds.

14. The method of claim 9, further comprising configuring the supportive frame as a channel frame configured to receive a baking surface having individual baking subunits formed therein.

15. A baking tray, comprising:
(a) a supportive frame, wherein the supportive frame includes two opposing endwalls, two opposing sidewalls, and an interior region;
(b) at least one bracket tab formed in each sidewall of the supportive frame,
(i) wherein each bracket tab formed in a sidewall is located directly across from a corresponding bracket tab formed in the opposing sidewall, thereby forming one or more pairs of corresponding bracket tabs, and
(ii) wherein each bracket tab is bent inward 90⁰ toward the interior region of the supportive frame;
(c) a plurality of individual baking molds attached to the supportive frame; and
(d) a cross brace attached to each opposing pair of bracket tabs for providing structural support to the baking tray.

16. The baking tray of claim 15, wherein the supportive frame is configured as a box channel having a panel configured to receive individual baking molds, or wherein the supportive frame is configured as a channel frame configured to receive a baking surface having individual baking subunits formed therein.

17. The baking tray of claim 15, wherein the supportive frame is laser cut from a piece of metal, and wherein each bracket tab is laser cut into the frame.

18. The baking tray of claim 15, wherein each baking subunit in the plurality of baking subunits is configured as a baking cup.

19. The baking tray of claim 15, wherein the pairs of bracket tabs are formed on the endwalls or on both the endwalls and the sidewalls, and wherein the supportive cross braces are mounted between these pairs of bracket tabs.

20. The baking tray of claim 15, wherein each cross brace is welded to a pair of bracket tabs to provide structural support to the baking tray.
